(19) United States
(12) Patent Application Publication
(10) Pub. No.: US 2007/0061475 A1
(43) Pub. Date: Mar. 15, 2007

(54) Methods and systems to enhance publication information with a communication feature

(75) Inventors: Henri Moissinac, Paris (FR); Jay Monahan, Los Gatos, CA (US)

Correspondence Address: SCHWEGMAN, LUNDBERG, WOESSNER & KLUTH, P.A., P.O. BOX 2938, MINNEAPOLIS, MN, 55402, US

(73) Assignee: eBay Inc.

(21) Appl. No.: 11/518,667

(22) Filed: Sep. 11, 2006

Related U.S. Application Data
(60) Provisional application No. 60/716,286, filed on Sep. 12, 2005.

(51) Int. Cl. G06F 15/16

(52) U.S. Cl. 709/229

(57) ABSTRACT

A system comprising a verification module to determine whether publication information satisfies predetermined criterion; and a user interface generator, in communication with the verification module, to electronically publish the publication information in association with communication initiation information if it is determined by the verification module that the publication information satisfies the predetermined criterion, the communication initiation information including identification information to identify a communication module and a network address of a first entity, the communication initiation information being selectable, at a first client computer, to initiate a communication from a second entity to the first entity.

### RELATED APPLICATIONS

This application claims the priority benefit of U.S. Provisional Application No. 60/716,286, filed Sep. 12, 2005, the content of which is incorporated herein by reference.

### TECHNICAL FIELD

This application relates generally to the technical field of electronic communications and, in one example, to a method and system to enhance publication information with a communication feature.

### BACKGROUND

Responsive to viewing published information (e.g., search results or an advertisement), a consumer may wish to initiate contact with an entity associated with the published information. For example, where the published information is an article or a listing describing a product or service, a consumer may wish to contact the seller to obtain further details regarding the product or service, or to negotiate for the purchase of the goods or services.

Similarly, where the published information is an advertisement, a consumer may wish to initiate contact with the seller that has posted the advertisement. Consumers are often discouraged from initiating such contact because of the effort required. For example, the contact process may require the consumer to look up the telephone number or email address of the seller, and then to manually dial the telephone number (or type in the email address) for the purpose of initiating communications.

### BRIEF DESCRIPTION OF DRAWINGS

Example embodiments are illustrated by way of example and not limitation in the figures of the accompanying drawings, in which like references indicate similar elements and in which:

FIG. 1 is a system diagram, according to an embodiment, illustrating computer systems, a network, a publication system, and a search result interface;

FIG. 2 is a system diagram, according to an embodiment, illustrating various software and hardware components;

FIG. 3 is a block diagram illustrating a method to facilitate communications, according to an embodiment; and

FIG. 4 shows a diagrammatic representation of machine in the example form of a computer system within which a set of instructions, for causing the machine to perform any one or more of the methodologies discussed herein, may be executed.

### DETAILED DESCRIPTION

In the following description, for purposes of explanation, numerous specific details are set forth in order to provide a thorough understanding of example embodiments. It will be evident, however, to one skilled in the art that the present disclosure may be practiced without these specific details.

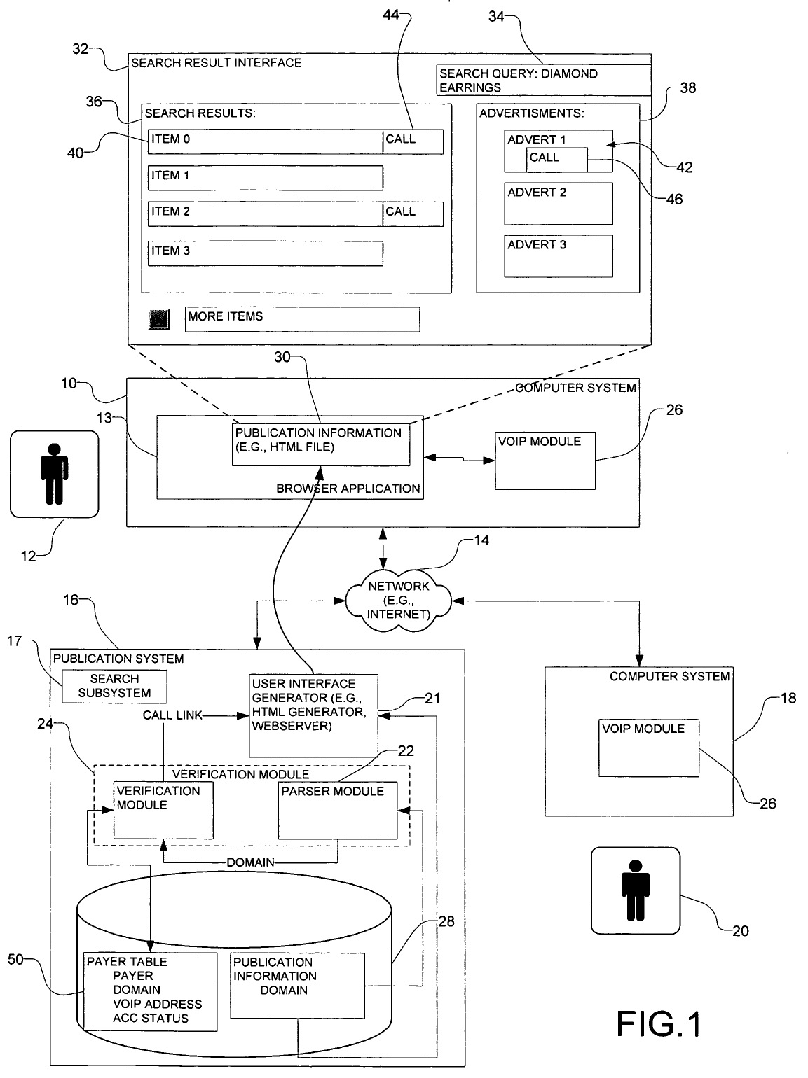

FIG. 1 is a system diagram, and illustrates a computer system 10 (e.g., client computer or other networked device) utilized by an entity (e.g., viewing user 12) to access a network 14 (e.g., the Internet) and thereby to communicate with a publication system 16, as well as computer systems 18 (e.g., client computer or other networked device) of other users (e.g., a publishing user 20) that may publish information utilizing the publication system 16. It will be appreciated that the entity described above need not be embodied as a human user and may be embodied as a software agent. For example, the software agent may be embodied as bookfinder.com of Berkley, Calif. or as mySimon made by CNET Networks, Inc. It will further be appreciated that a human user is not limited to interacting with another human user but may interact with a software agent.

The computer system 10 (e.g., client computer) is shown to host a client module, in the example form of a browser application 13 (e.g., MS Internet Explorer, or FireFox browser), and a communication module, in the example form of a Voice over IP (VoIP) module 26. In other embodiments, the communication module may be an electronic message (e.g., e-mail) module, an instant messenger (IM) module or the like. The publication system 16 hosts a user interface generator 21 (e.g., HTML Generator), and a verification module 24 that includes a parser module 22. The publication system 16 also includes a database 28, which is accessible via the above identified modules. A specific example embodiment is discussed below, and broader and alternative embodiments are then discussed subsequent to the specific example.

In a specific example embodiment, the publication system 16 includes a search sub-system 17 via which a user may submit a search query to the publication system 16, responsive to which the publication system 16 provides search results, the search results pertaining to publication data (e.g., publication information) stored by the publication system 16 or accessible at other computer systems via the network 14. For example, the viewing user 12, utilizing the browser application 13, may navigate to a search input interface presented by the publication system 16, and input a search query (e.g., diamond earrings). The search query is then communicated to the publication system 16 via the network 14. Responsive to the search query, the publication system 16 may generate, and communicate to the computer system 10, a user interface in the form of an HTML file 30 that embodies the search results. The HTML file 30 may be sent to the computer system 10 as an HTTP communication for display by the browser application 13 or may be embodied in an email message sent to an email client that may execute on the computer system 10. In other embodiments, the communication from the publication system 16 to the computer system 10 may be formatted as XHTML, WML, XML files or a file utilizing other descriptor language formats.

As shown in FIG. 1, the HTML file 30 may then be rendered by the browser application 13 to generate a search result interface 32, which is displayed by the computer system 10 to the viewing user 12. The example search result interface 32 is shown to display the original search query 34 responsive to which the search results were generated, a number of search results 36, and paid-placement advertisements 38.

Specifically, considering the search results 36 and the advertisements 38, text associated with each search result or advertisement is hypertext-linked to a location accessible via the network 14. For example, hypertext (e.g., a URL) associated with each search result or advertisement may reference a location on the publication system 16, or a location at another network domain accessible via the network 14. For example, consider that where search result instance 40 pertains to a product offering by merchant ABC, text associated with the search result instance 40 may be hypertext-linked to a website operated by merchant ABC (e.g., www.merchantABC.com/products/product123). In this example, “merchantABC.com” represents a domain operated by the relevant merchant. Accordingly, user selection of the search result instance 40 will cause the browser application 13 to be redirected to the address “www.merchantABC.com/products/product123”, where further details regarding the relevant product may be obtained and displayed within the browser application 13. Similarly, text associated with an advertisement 42 may be hypertext-linked to a location within a domain operated by a relevant merchant.

In an example embodiment, in addition to including a hypertext-link in a search result instance (or an advertisement) in the HTML file 30, communication initiation information (e.g., a selectable text or some other selectable character, such as icon) may be associated with a search result instance (or an advertisement). The selectable text may be user-selectable or machine-selectable to invoke the VoIP module 26 to initiate a VoIP communication session utilizing information embedded in the HTML file 30.

An embodiment also envisages that, prior to enabling such a VoIP contact session, verification is performed to determine whether one or more criterion have been satisfied. For example, verification may be formed to determine whether a recipient of such a VoIP call (e.g., a merchant) has registered with and/or provided payment (or other value) to the publication system 16. In one embodiment, this verification is performed at the client computer, (e.g., the computer system 10), while in another embodiment, the verification may be performed on the server side (e.g., the publication system 16).

FIG. 1 indicates that communication initiation information in the form of a call-link (e.g., a “call” button 44) may be associated with the search result instance 40, and similarly that a call-link (e.g., “call” button 46) may be associated with the advertisement 42. In each instance, the relevant call-link is rendered, by the browser application 13, in association with either the search result instance or the advertisement as a result of the inclusion within or insertion into the HTML file 30 of appropriate coding.

The coding associated with a call-link, in one embodiment, is only included in the HTML file 30 delivered to the computer system 10 if an entity, associated with the relevant publication data (e.g., a search result instance or the advertisement) has satisfied one or more criterion (e.g., has registered with and/or provided payment to the publication system 16 for the inclusion of this publication enhancement). For example, when generating the HTML file 30, the publication system 16 may access the database 28, and more specifically a payer table 50 maintained within the database 28, to determine whether an entity associated with the publication data (e.g., a merchant) has made a payment to the publication system 16. Such a payment may be made for the inclusion of a VoIP call initiation feature in generated HTML files, such that the VoIP call initiation feature is displayed and presented to a user in association with publication information published on behalf of the relevant publishing user (e.g., the merchant). In one embodiment, the verification module 24 may verify whether the party has made the payment by reading an account status in the payer table 50.

For example, prior to the inclusion of a search result instance 40 or an advertisement 38 in an HTML file 30 by the publication system 16, the parser module 22 may retrieve the relevant publication information to be included in the search results 36 (or the advertisement), and parse the publication information to determine whether a domain associated with the publication information (e.g., “merchantABC.com”) corresponds to the domain of an entity that has paid the publication system 16 for the display of a call-link (e.g., a call button 44 or 46) in association with publication information. To this end, the verification module 24 receives a domain for each instance of publication data to be included in an HTML file 30, and accesses the payer table 50 within the database 28 to determine an account status for an owner of the domain. For example, in the event that an entry does not exist within the payer table 50 for the relevant domain, or an entry does exist but indicates the account status as being invalid (e.g. as a result of failure to make a payment), the verification module 24 will cause a call-link not to be displayed in conjunction with the relevant publication information. Rules implemented by the verification module 24 may be flexible, and allow a payer/affiliate a grace period to rectify any issues pertaining to an account.

Further, the service may even be offered for free, and the verification performed by the verification module 24 may simply be to determine whether an entity has registered with an appropriate program (e.g. offered by the publication system 16 or by another entity). It yet a further embodiment, the verification module 24 may perform a check to ascertain whether the entity meets some other defined criterion (e.g., in the scenario in which the publication system 16 is part of a commerce system, whether the entity has transacted a predetermined volume of business or met some sales or reputation criteria).

Assuming that the verification module 24 determines, for a particular instance of publication data, that an owner of a domain associated with the publication information has satisfied the predetermined criteria, the verification module 24 will communicate with the user interface generator 21 in order to instruct the user interface generator 21 to include a call-link within the HTML file 30. In one embodiment, the call-link includes identification information in the form of a VoIP address, retrieved from the payer table 50, as well as an instruction to invoke the VoIP module 26, resident on the computer system 10.

The user interface generator 21 then generates the HTML file 30 to include call-links that are displayed in association with appropriate instances of publication information, where after the HTML file 30 is communicated, via the network 14, to the computer system 10 for display by the browser application 13.

Turning now to operations that occur at the computer system 10, when a viewing user 12 is presented with the search result interface 32, the viewing user 12 may click and select a call-link (e.g. call button 44 or call button 46). User selection of the call-link is detected by the browser application 13, and the underlying instruction and VoIP address are processed. In one embodiment, the call-link or communication initiation information may include identification information in the form of a universal resource locater (e.g., network address) that instructs the browser application 13 as to the identity and/or location of the communication module (e.g., VoIP module 26) on the client computer. Further, the identification information may also include parameters that are passed by the browser application 13 to the communication module, the parameters including a network address of the computer system 18 or the publishing user 20 and other parameters that may facilitate communication. In the present example, responsive to the relevant instruction, the browser application 13 invokes the VoIP module 26, and communicates the VoIP address of the publishing user 20 to the VoIP module 26. The VoIP module 26 then proceeds to initiate a VoIP call (e.g., to a telephone number or to a further VoIP module 26 executing on another computer system 18). In this manner, the viewing user 12 is conveniently able to initiate communications with the publishing user 20.

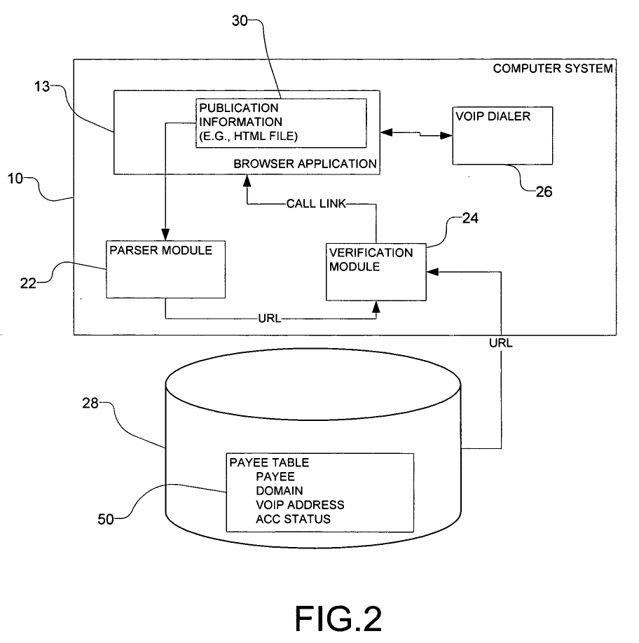

FIG. 2 illustrates a further example embodiment, in which the parser module 22 and the verification module 24 reside on the computer system 10 (e.g., client computer).

In this case, the call-links (e.g., communication initiation information including call-buttons 44 and 46) are inserted into the HTML file 30 on the client side, as opposed to the server side. In this case, prior to rendering and displaying each instance of publication data, the browser application 13 seeks verification that the call-link should be displayed. In one embodiment, the HTML file 30 may be processed by the parser module 22 to determine whether the domain of each URL associated with the publication information included in the HTML file 30 corresponds to the domain of a publishing user that has made payment for the presentation of a call-link. To this end, the parser module 22 parses relevant URLs out of the HTML file 30, communicates these to the verification module 24, which accesses the database 28 (e.g., which may be maintained locally or remotely). Should the verification module 24 confirm a domain as being associated with a publishing user 20 that has made the appropriate payment (or has appropriately registered for example in an affiliate program), the verification module 24 provides a call-link to the browser application 13, which the browser application 13 inserts or includes at the appropriate location within the HTML file 30.

In one embodiment, the provision of such functionality to legacy browser applications 13 may be enabled with a browser plug-in (a hardware or software module that enables the browser application 13 to provide the necessary functionality for the described feature).

In the above described embodiment, a domain is extracted from a hypertext link included in the search result interface 32, and a determination is made as to whether a party associated with the domain (e.g., owner of the domain), included in the hypertext link, meets predetermined criteria (e.g., has made an appropriate payment to the publication system 16 for a publication enhancement). If so, a call-link is then displayed in conjunction with the hypertext link. In a further embodiment, the example system may operate to parse publication data other than hypertext links to identify any text (or alphanumeric characters) within publication information or publication data, and determine whether an entity associated with the identified text meets certain qualifications (e.g., is registered with an “affiliate” program operated by the publication system 16 or has made an appropriate payment to the publication system 16). If so, the identified text may be hypertext linked to a location (e.g., a network or Internet location) associated with the relevant entity.

Consider an example in which an online publication system (e.g., an online magazine, newspaper or blog) electronically publishes an article relating to MP3 music players. In this article, a number of MP3 players are mentioned by name, these players including for example the iPod MP3 player manufactured by Apple Computer Corporation and the Zen MP3 player manufactured by Creative Technologies. In this case, the parser module 22 (e.g., resident at either the publication system 16 or on a computer system 10) parses the article prior to display. The parsing is performed to identify terms (e.g., text, alphanumeric characters, etc.) within the article that correspond to predetermined terms stored within a terms table (not shown) that is maintained within the database 28. Each predetermined term within the terms table may furthermore be associated to a payer that has been registered in the payer table 50. If terms are identified within the publication information as corresponding to predetermined terms within the terms table, the payer details are communicated from the parser module 22 to the verification module 24. The verification module 24, in turn, confirms that the relevant payer is in good standing (e.g., is registered with an affiliate program, has made an appropriate payment or meets some other commerce or reputation criteria). Assuming the relevant payer is in good standing, the verification module 24 may communicate communication initiation information to the user interface generator 21. In one embodiment the communication initiation information may include identification information (e.g., call identifier, URL, etc.) that identifies the communication module 26 (e.g., voice over internet protocol (VoIP) module, browser application, instant messaging module, electronic message module, etc.) and a network address of the second party (e.g., a hypertext link, Voice over IP network address, IM network address, email address, web address, etc.). The user interface generator 21 then associates the communication initiation information of the payer with the relevant term in the publication data. For example, where the communication initiation information includes identification information that includes a hypertext link, the identified term (e.g. “iPod” or “Zen”) may be hypertext linked to a website operated by the relevant company. Similarly, where the communication initiation information includes identification information that includes a VoIP module 26, the identified term may be associated with a URL that may be used to invoke the VoIP module 26 to initiate a call to the relevant corporation.

In this way, when the publication data is displayed to a viewing user 12, the viewing user 12 may select the identified term (or an icon associated at the relevant term) to initiate communications with the payer. Again, these communications could be a web session, a VoIP session, an IM session or an email communication, for example.

The above example has also dealt with including communication initiation information for a single merchant in publication data. In a further example embodiment, communication initiation information for multiple entities (e.g., payers) may be associated with a term (or terms) of publication data. For example, where the term “pizza”, within a predetermined proximity (e.g., number of terms) in publication information to the terms “Palo Alto”, is encountered by the parser module 22, the identification information for a number of entities (e.g., pizza vendors located in Palo Alto) may be associated with the term “pizza” in the publication data (e.g., the parser module 22 is triggered by the relative position of two predetermined terms in the published information). In this example, the term “pizza” may be visually distinguished within the publication data (e.g., via a user-selectable icon to invoke display of information concerning the number of entities). The display of information pertaining to the number of entities (e.g., parties) may be performed within a pop-up window. The displayed information may include contact initiation information for each of the entities (e.g., telephone numbers, addresses, etc.) and communication initiation information associated with the respective entities. The user may then initiate communications with one or more of the entities by selecting a user selectable icon associated with communication initiation information to invoke the appropriate communication module (e.g., VoIP module 26) that is associated with the respective paying entity.

As noted above, to qualify for publication enhancement, whereby text within publication data is enhanced to enable initiation of communications with a payer, the payer may have registered with an “affiliate” program operated by or associated with the publication system 16. In this case, the communication initiation information communicated from the verification module 24 to the user interface generator 21, and accordingly included in the HTML file 30, may include identification information that identifies the “affiliate” program that is associated with or operated by the publication system 16. For example, upon initiation of communications between the computer system 10 and the computer system 18 of a payer, for example, the payer may be enabled to identify the communication as having been initiated as a result of registration with the affiliate program associated with or operated by the publication system 16. In this way, the payer may track communications that are initiated as a result of registration in the relevant affiliate program. Other embodiments may communicate other types of identification information including the criteria information previously described (e.g., whether the first party transacts a predetermined volume of business, exceeds a sales goal, achieves satisfactory reputation criteria, and registers with an affiliation program operated by a publishing system that publishes the published information).

In yet a further embodiment, for each inclusion or insertion of communication initiation information in the HTML file 30 by the user interface generator 21, an appropriate record of inclusion of this communication initiation information within the publication data may be registered at the publication system 16 (e.g., within the payer table 50). In this embodiment, the payer may be charged a certain amount for inclusion of communication initiation information in publication information that is published by the publication system 16. For example, a record of inclusion may be maintained by registering the instance of the inclusion or insertion in an account that is associated with the payer. The registering may further include maintaining a count of total insertions that may be utilized to determine an amount that the payer is charged.

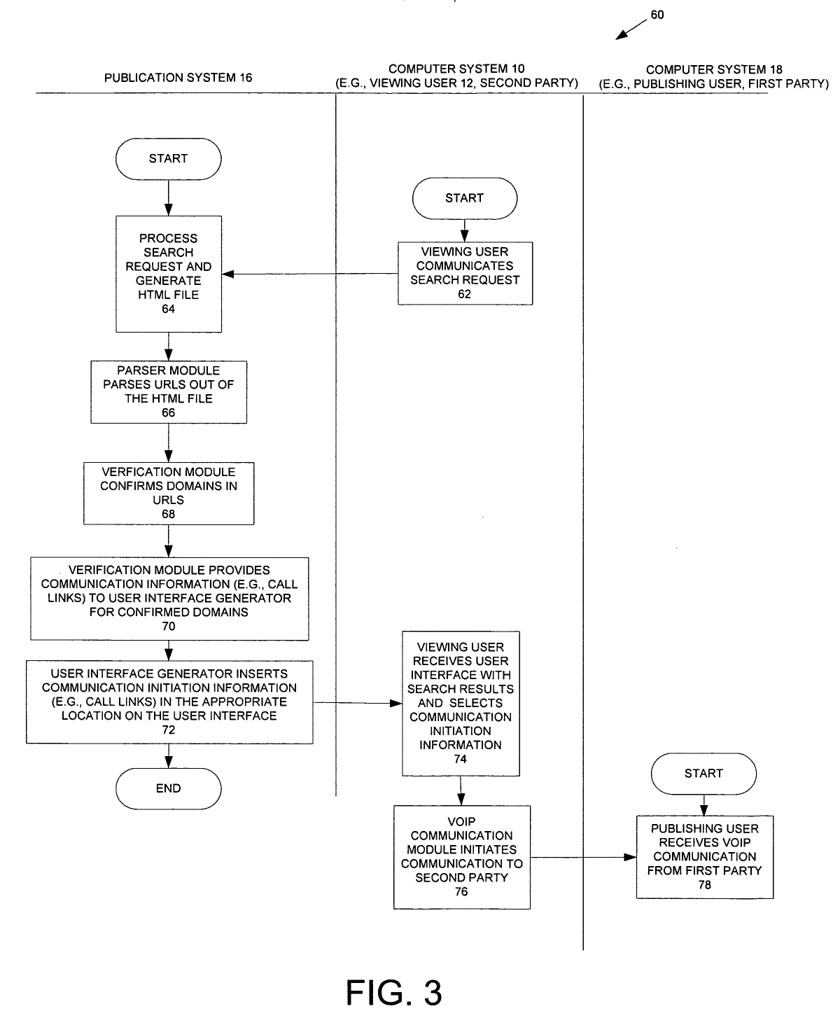

FIG. 3 is a block diagram illustrating a method 60, according to an embodiment, to facilitate communication. Operations associated with the publication system 16 are illustrated on the left, operations associated with a computer system 10 (e.g., second party) are illustrated in the middle, and operations associated with a computer system 18 (e.g., first party) are illustrated on the right. The method 60 commences at operation 62 with a viewing user 12 at the computer system 10 communicating a search query to the publication system 16. For example, the viewing user may enter a search query for “diamond earrings.”

At operation 64, the publication system 16 receives the search query, generates search results in the form of a search result interface 32 that includes publication information. For example, the search result interface 32 may take the form of an HTML file 30 that includes publication information in the form of search result instances 40 and advertisements 38 that are respectively user selectable.

At operation 66, the parser module 22 receives the HTML file 30 and parses relevant URLs (e.g., URLs associated with search result instances 40 and advertisements 38) out of the HTML file 30, to determine whether the publication information satisfies predetermined criteria. For example, the parser module 22 may compare a domain included in the URL to a domain that is associated with a particular payer (e.g., publishing user 20) in a payer table 50. If the parser module 22 determines that the domain is associated with a payer then the parser module 22 may communicate the domain to the verification module 24.

At operation 68, the verification module 24 accesses a database 28 to confirm whether the domain received from the parser application 22 corresponds to a publishing user 20 that has made appropriate payment or satisfied some other predetermined criteria. In one embodiment the verification application 24 may determine whether the publishing user 20 has paid to facilitate communication by reading an account status associated with the publishing user 20

At operation 70, the verification module 24 communicates communication initiation information that corresponds to the confirmed domains to a user interface generator 21. For example, the communication initiation information may include a call link that is user selectable and identification information that includes an instruction or a URL that is utilized to invoke a VoIP module 26, a network address of a second party in the form of a VoIP address of the publishing user 20, and an indication that the payee or second party has registered in an affiliate program.

At operation 72, the user interface generator 21 electronically publishes the publication information in association with communication information by inserting the call links into the HTML file 30 and enabling access to the HTML file 30. Further at the operation 72 the publication system 16 communicates the HTML file 30 to the computer system 10.

At operation 74, the computer system 10 receives the HTML file 30 and displays the HTML file to the viewing user 12. For example, the computer system 10 may display call buttons 44 in association with the corresponding search result instances 40 and call buttons 46 in association with corresponding advertisements 42. Further, at operation 74 the viewing user 12 may select a call-link (e.g., call button 44 or call button 46) to initiate VoIP communications with the publishing user 20.

At operation 76, the browser application 13, responsive to the selection of the call-link, invokes a VoIP module 26 which initiates a communication in the form of a VoIP telephone call to the publishing user 20 at the computer system 18.

At operation 78, at the computer system 18, a VoIP module 26 may respond to the received communication by generating an audible ringing sound that may be heard by the publishing user 20. Further, the VoIP module 26 may respond to a publishing user 20 that answers the call by establishing a VoIP connection with the viewing user 12.

In another embodiment, the publication system 18 may electronically publish the publication information in association with communication initiation information without first receiving a request for search results. In yet another embodiment a client computer (e.g., computer system 18) may host the publication system and accordingly electronically publish the publication information in association with communication initiation information. For example, the computer system 18 may host the publication system and accordingly respond to search requests from the computer system 10 as well as responding to a request to establish a VoIP connection.

A technical advantage of the above described system may be found in its modular approach to communications. For example, the publication information may be associated with a communication module that may include a voice over Internet protocol communication module for voice of Internet communications, an electronic message communication module for electronic messaging communications and an instant message communication module for instant messaging communications. In each instance, communication information may be selectable to initiate the respective type of communication.

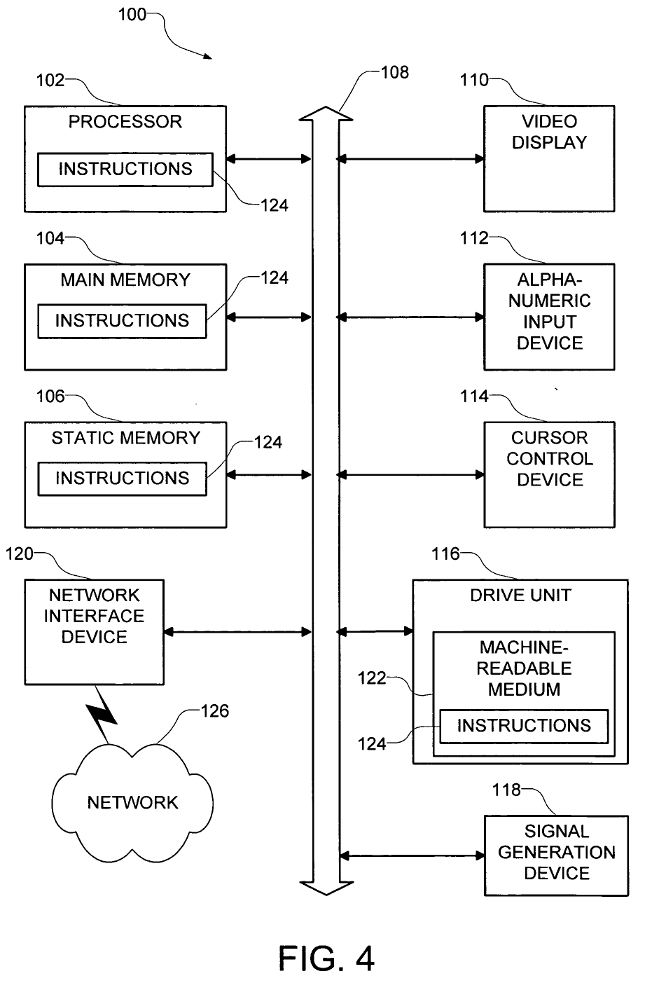

FIG. 4 shows a diagrammatic representation of a machine in the exemplary form of a computer system 100 within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a television, a Personal Digital Assistant (PDA), a cellular (or mobile) telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 100 includes a processor 102 (e.g., a central processing unit (CPU), a graphics processing unit (GPU) or both), a main memory 104 and a static memory 106, which communicate with each other via a bus 108. The computer system 100 may further include a video display unit 110 (e.g., a liquid crystal display (LCD) or a cathode ray tube (CRT)). The computer system 100 also includes an alphanumeric input device 112 (e.g., a keyboard), a user interface (UI) navigation device 114 (e.g., a mouse), a disk drive unit 116, a signal generation device 118 (e.g., a speaker) and a network interface device 120.

The disk drive unit 116 includes a machine-readable medium 122 on which is stored one or more sets of instructions and data structures (e.g., software 124) embodying or utilized by any one or more of the methodologies or functions described herein. The software 124 may also reside, completely or at least partially, within the main memory 104 and/or within the processor 102 during execution thereof by the computer system 100, the main memory 104 and the processor 102 also constituting machine-readable media.

The software 124 may further be transmitted or received over a network 126 via the network interface device 120 utilizing any one of a number of well-known transfer protocols (e.g., HTTP).

While the machine-readable medium 122 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies described herein, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

What is claimed is:

1. A system comprising:
a verification module to determine whether publication information satisfies predetermined criterion; and
a user interface generator, in communication with the verification module, to electronically publish the publication information in association with communication initiation information if it is determined by the verification module that the publication information satisfies the predetermined criterion, the communication initiation information including identification information to identify a communication module and a network address of a first entity, the communication initiation information being selectable, at a first client computer, to initiate a communication from a second entity to the first entity.

2. The system of claim 1, wherein the first entity includes any one of a group of first entities including a first party and a first software agent, and wherein the second entity includes any one of a group of second entities including a second party and a second software agent.

3. The system of claim 2, wherein the communication initiation information is selectable to activate the communication module to initiate the communication from the second party to the first party.

4. The system of claim 2, wherein the communication module is any one of a group of communication modules including a voice over internet protocol (VoIP) communication module, an electronic message communication module, and an instant messaging communication module.

5. The system of claim 2, wherein the verification module receives a domain that is extracted from a universal resource locater that is used to locate the publication information and to compare the domain of the universal resource locater to a plurality of domains that are respectively associated to a plurality of parties that includes the first party.

6. The system of claim 5, wherein the verification module verifies whether the first party satisfies at least one predetermined user criterion.

7. The system of claim 6, wherein the verification module reads an account status that is associated with the first party to determine whether the first party has paid to facilitate communication.

8. The system of claim 6, wherein the verification module determines whether the first party satisfies any one of a group of predetermined user criterion including whether the first party transacts a predetermined volume of business, exceeds a sales goal, achieves satisfactory reputation criterion, and registers with an affiliation program operated by a publishing system that publishes the publication information.

9. The system of claim 2, wherein the communication from the second party to the first party is utilized to communicate criterion information to the first party, and wherein the criterion information includes identification information that identifies the second party as having registered in an affiliate program that is associated with a publishing system.

10. The system of claim 2, wherein the user interface generator registers the publication of the communication initiation information in an account that is associated with the first party and maintains a total that is utilized to determine an amount of payment collected from the first party.

11. The system of claim 1, wherein the verifying module verifies whether an author of the publication information satisfies the predetermined criterion.

12. The system of claim 1, wherein the predetermined criterion includes any one of a group of criterion including registration with a publisher of the publication information, payment to the publisher of the publication information, reputation criterion and transaction history criterion.

13. The system of claim 1, wherein the verifying module verifies whether the first party satisfies the predetermined criterion.

14. The system of claim 1, wherein the user interface generator electronically publishes the publication information to a second client computer that hosts the publication system.

15. The system of claim 1, wherein the verification module includes a parser module and the parser module compares the parsed terms to at least one predetermined term that is associated with the first party.

16. The system of claim 15, wherein the user interface generator electronically publishes additional communication initiation information in association with the publication information responsive to a verification module that identifies that additional parties are associated with the at least one predetermined term.

17. The system of claim 1, wherein the parsing module identifies a first predetermined term in the publication information that is positioned a predetermined number of terms from a second predetermined term in the publication information.

18. A method comprising:
determining whether publication information satisfies a predetermined criterion; and
if so, electronically publishing the publication information in association with communication initiation information, the communication initiation information including identification information identifying a communication module and a network address of a first entity, the communication initiation information being selectable, at a client computer, to initiate a communication from a second entity to the first entity.

19. The method of claim 18, wherein the first entity includes any one of a group of first entities including a first party and a first software agent, and wherein the second entity includes any one of a group of second entities including a second party and a second software agent.

20. The method of claim 18, wherein the communication initiation information is selectable to activate the communication module to initiate the communication from the second entity to the first entity.

21. The method of claim 19, wherein the communication module is any one of a group of communication modules including a voice over internet protocol (VoIP) communication module, an electronic message communication module, and an instant messaging communication module.

22. The method of claim 19, wherein the determining whether the publication information satisfies the predetermined criterion includes receiving a domain that is extracted from a universal resource locater that is used to locate the publication information and comparing the domain of the universal resource locater to a plurality of domains that are respectively associated with a plurality of parties that includes the first party.

23. The method of claim 19, wherein the determining includes verifying whether the first party satisfies at least one predetermined user criterion.

24. The method of claim 23, wherein the verifying whether the first party satisfies the at least one predetermined user criterion includes reading an account status that is associated with the first party and determining whether the first party has paid to facilitate communication based on the account status.

25. The method of claim 23, wherein the verifying whether the first party satisfies the at least one predetermined user criterion includes determining whether the first party satisfies any one of a group of predetermined criterion including whether the first party transacts a predetermined volume of business, exceeds a sales goal, achieves satisfactory reputation criteria, and registers with an affiliation program operated by a publishing system that publishes the publication information.

26. The method of claim 19, wherein the communication from the second party to the first party is utilized to communicate criterion information to the first party, and wherein the criterion information includes identification information that identifies the second party as having registered in an affiliate program that is associated with a publishing system.

27. The method of claim 19, wherein electronically publishing the publication information includes registering the communication information in an account that is associated with the first party and maintaining a total that is utilized to determine an amount of payment collected from the first party.

28. The method of claim 18, wherein the determining includes verifying whether an author of the publication information satisfies the predetermined criterion.

29. The method of claim 18, wherein the predetermined criterion includes any one of a group of predetermined criterion including registration with a publisher of the publication information, payment to the publisher of the publication information, reputation criterion and transaction history criterion.

30. The method of claim 18, wherein the determining includes determining whether the first party satisfies the predetermined criterion.

31. The method of claim 18, wherein the electronically publishing of the publication information includes electronically publishing to any one computer from a group of computers including a second client computer that hosts the publication system and a server computer that hosts the publication system.

32. The method of claim 18, wherein the determining includes parsing terms and comparing the parsed terms to at least one predetermined term that is associated with the first party.

33. The method of claim 32, wherein the electronically publishing includes publishing additional communication information in association with the publication information responsive to identifying additional parties that are associated with the at least one predetermined term.

34. The method of claim 32, wherein the parsing the terms includes identifying a first predetermined term in the publication information that is positioned a predetermined number of terms from a second predetermined term in the publication information.

35. A tangible machine readable medium storing a set of instructions that, when executed by a machine, cause the machine to:
determine whether publication information satisfies predetermined criterion; and
if so, electronically publish the publication information in association with communication initiation information, the communication initiation information to include identification information to identify a communication module and a network address of a first entity, the communication initiation information being selectable, at a first client computer, to initiate a communication from a second entity to the first entity.

36. A system comprising:
a first means for determining whether publication information satisfies predetermined criterion; and
if so, a second means, in communication with the first means, for electronically publishing the publication information in association with communication initiation information if it is determined by the first means that the publication information satisfies the predetermined criterion, the communication initiation information including identification information to identify a communication module and a network address of a first entity, the communication initiation information selectable, at a first client computer, to initiate a communication from a second entity to the first entity.
